(19) United States
(12) Patent Application Publication
(10) Pub. No.: US 2019/0042098 A1
(43) Pub. Date: Feb. 7, 2019

(54) REDUCTION OF WRITE AMPLIFICATION OF SSD WITH INTEGRATED MEMORY BUFFER

(71) Applicant: Intel Corporation, Santa Clara, CA (US)

(72) Inventors: Peng Li, Beaverton, OR (US); Sanjeev Trika, Portland, OR (US)

(73) Assignee: Intel Corporation, Santa Clara, CA (US)

(21) Appl. No.: 16/003,219

(22) Filed: Jun. 8, 2018

(51) Int. Cl. G06F 3/06

(52) U.S. Cl. CPC G06F 3/065; G06F 3/068; G06F 3/0619

(57) ABSTRACT

An embodiment of a semiconductor apparatus may include technology to define a region for a backed-up portion of a volatile memory, and designate the region as a part of a nonvolatile memory. Other embodiments are disclosed and claimed.

### TECHNICAL FIELD

Embodiments generally relate to storage systems. More particularly, embodiments relate to reduction of write amplification of a solid state drive (SSD) with an integrated memory buffer (IMB).

### BACKGROUND

A storage device such as a SSD may include nonvolatile memory (NVM) media. For some NVM media, write operations may take more time and/or consume more energy as compared to read operations. Some NVM media may have a limited number of write operations that can be performed on each location. Access to the contents of the SSD may be supported with a protocol such as NVM EXPRESS (NVMe), Revision 1.3, published May 2017 (nvmexpress.org).

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of an electronic processing system according to an embodiment;

FIG. 2 is a block diagram of an example of a semiconductor apparatus according to an embodiment;

FIGS. 3A to 3C are flowcharts of an example of a method of controlling memory according to an embodiment;

FIG. 4 is a block diagram of another example of an electronic processing system s according to an embodiment; and

FIG. 5 is a block diagram of an example of a storage system according to an embodiment.

### DESCRIPTION OF EMBODIMENTS

Various embodiments described herein may include a memory component and/or an interface to a memory component. Such memory components may include volatile and/or nonvolatile memory (NVM). NVM may be a storage medium that does not require power to maintain the state of data stored by the medium. In one embodiment, the memory device may include a block addressable memory device, such as those based on NAND or NOR technologies. A memory device may also include future generation nonvolatile devices, such as a three dimensional (3D) crosspoint memory device, or other byte addressable write-in-place NVM devices. In one embodiment, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thiristor based memory device, or a combination of any of the above, or other memory. The memory device may refer to the die itself and/or to a packaged memory product. In particular embodiments, a memory component with non-volatile memory may comply with one or more standards promulgated by the Joint Electron Device Engineering Council (JEDEC), such as JESD218, JESD219, JESD220-1, JESD223B, JESD223-1, or other suitable standard (the JEDEC standards cited herein are available at jedec.org).

Volatile memory may be a storage medium that requires power to maintain the state of data stored by the medium. Non-limiting examples of volatile memory may include various types of RAM, such as dynamic random access memory (DRAM) or static random access memory (SRAM). One particular type of DRAM that may be used in a memory module is synchronous dynamic random access memory (SDRAM). In particular embodiments, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4 (these standards are available at jedec.org). Such standards (and similar standards) may be referred to as DDR-based standards and communication interfaces of the storage devices that implement such standards may be referred to as DDR-based interfaces.

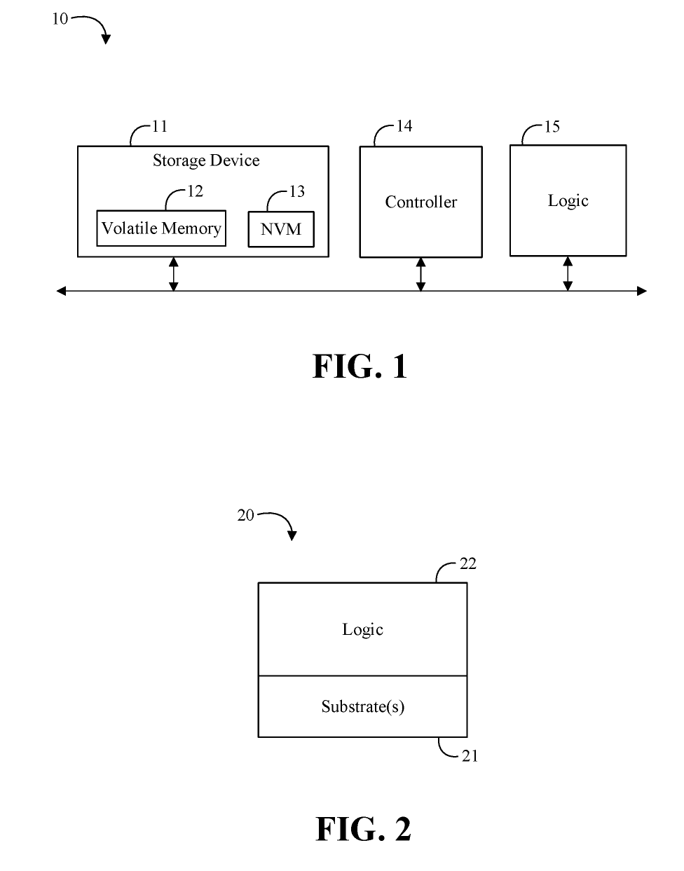

Turning now to FIG. 1, an embodiment of an electronic processing system 10 may include a storage device 11 including volatile memory 12 and NVM 13, wherein at least a portion of the volatile memory is backed-up, a controller 14 communicatively coupled to the storage device 11, and logic 15 communicatively coupled to the controller 14 to define a region for the backed-up portion of the volatile memory 12, and designate the region as a part of the NVM 13. In some embodiments, the logic 15 may be configured to prioritize data for storage to the region based on one or more of a frequency of write operations for the data and a size of the data, and/or to prioritize information from a multi-level database for storage to the region based on a level of the information in the multi-level database. For example, the multi-level database may include a tree-based key-value (KV) database (e.g., a log structure merge (LSM) KV database, a B−tree KV database, a B+tree KV database, etc.). In some embodiments, the logic 15 may be configured to assign the region to a NVM namespace (e.g., for NVMe-compatible implementations). For example, the storage device 11 may include a SSD, and the volatile memory may include an integrated memory buffer (IMB). In some embodiments, the logic 15 may be located in, or co-located with, various components, including the controller 14 (e.g., on a same die).

Embodiments of each of the above storage device 11, volatile memory 12, NVM 13, controller 14, logic 15, and other system components may be implemented in hardware, software, or any suitable combination thereof. For example, hardware implementations may include configurable logic such as, for example, programmable logic arrays (PLAs), field programmable gate arrays (FPGAs), complex programmable logic devices (CPLDs), or fixed-functionality logic hardware using circuit technology such as, for example, application specific integrated circuit (ASIC), complementary metal oxide semiconductor (CMOS) or transistor-transistor logic (TTL) technology, or any combination thereof. Embodiments of the controller 14 may include a general purpose controller, a special purpose controller (e.g., a memory controller, a storage controller, a NVM controller, etc.), a micro-controller, a processor, a central processor unit (CPU), a micro-processor, etc.

Alternatively, or additionally, all or portions of these components may be implemented in one or more modules as a set of logic instructions stored in a machine- or computer-readable storage medium such as random access memory (RAM), read only memory (ROM), programmable ROM (PROM), firmware, flash memory, etc., to be executed by a processor or computing device. For example, computer program code to carry out the operations of the components may be written in any combination of one or more operating system (OS) applicable/appropriate programming languages, including an object-oriented programming language such as PYTHON, PERL, JAVA, SMALLTALK, C++, C# or the like and conventional procedural programming languages, such as the “C” programming language or similar programming languages. For example, the volatile memory 12, NVM 13, persistent storage media, or other system memory may store a set of instructions which when executed by the controller 14 cause the system 10 to implement one or more components, features, or aspects of the system 10 (e.g., the logic 15, defining the region for the backed-up portion of the volatile memory, designating the region as a part of the NVM, etc.).

Turning now to FIG. 2, an embodiment of a semiconductor apparatus 20 may include one or more substrates 21, and logic 22 coupled to the one or more substrates 21, wherein the logic 22 is at least partly implemented in one or more of configurable logic and fixed-functionality hardware logic. The logic 22 coupled to the one or more substrates 21 may be configured to define a region for a backed-up portion of a volatile memory, and designate the region as a part of a NVM. In some embodiments, the logic 22 may be configured to prioritize data for storage to the region based on one or more of a frequency of write operations for the data and a size of the data, and/or to prioritize information from a multi-level database for storage to the region based on a level of the information in the multi-level database. For example, the multi-level database may include a tree-based KV database. In some embodiments, the logic 22 may be configured to assign the region to a NVM namespace. For example, the volatile memory may include an IMB of a SSD. In some embodiments, the logic 22 may be integrated with a memory controller on the one or more substrates 21. In some embodiments, the logic 22 coupled to the one or more substrates 21 may include transistor channel regions that are positioned within the one or more substrates 21.

Embodiments of logic 22, and other components of the apparatus 20, may be implemented in hardware, software, or any combination thereof including at least a partial implementation in hardware. For example, hardware implementations may include configurable logic such as, for example, PLAs, FPGAs, CPLDs, or fixed-functionality logic hardware using circuit technology such as, for example, ASIC, CMOS, or TTL technology, or any combination thereof. Additionally, portions of these components may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

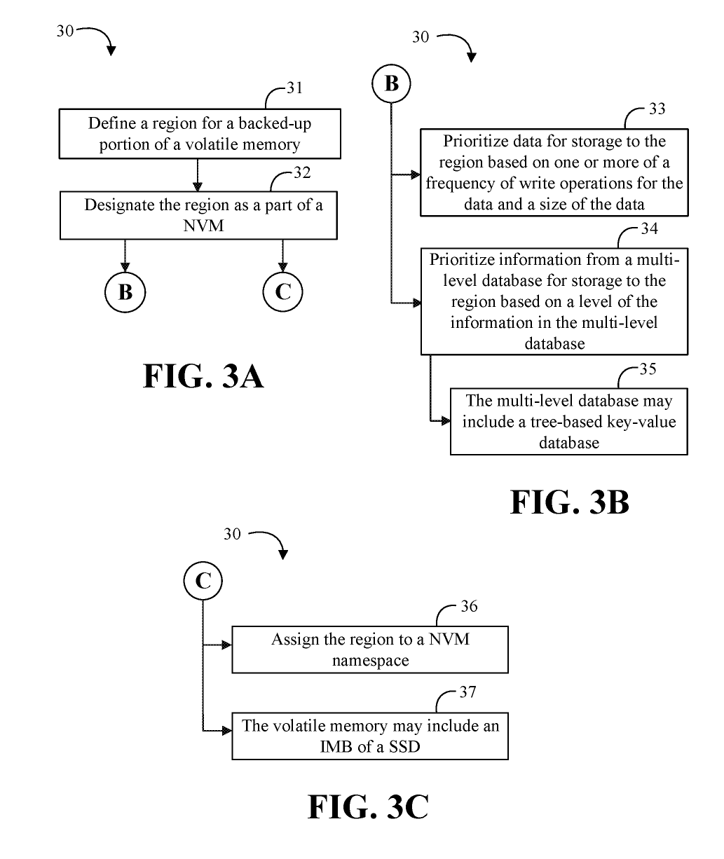

The apparatus 20 may implement one or more aspects of the method 30 (FIGS. 3A to 3C), or any of the embodiments discussed herein. In some embodiments, the illustrated apparatus 20 may include the one or more substrates 21 (e.g., silicon, sapphire, gallium arsenide) and the logic 22 (e.g., transistor array and other integrated circuit/IC components) coupled to the substrate(s) 21. The logic 22 may be implemented at least partly in configurable logic or fixed-functionality logic hardware. In one example, the logic 22 may include transistor channel regions that are positioned (e.g., embedded) within the substrate(s) 21. Thus, the interface between the logic 22 and the substrate(s) 21 may not be an abrupt junction. The logic 22 may also be considered to include an epitaxial layer that is grown on an initial wafer of the substrate(s) 21.

Turning now to FIGS. 3A to 3C, an embodiment of a method 30 of controlling memory may include defining a region for a backed-up portion of a volatile memory at block 31, and designating the region as a part of a NVM at block 32. Some embodiments of the method 30 may further include prioritizing data for storage to the region based on one or more of a frequency of write operations for the data and a size of the data at block 33, and/or prioritizing information from a multi-level database for storage to the region based on a level of the information in the multi-level database at block 34. For example, the multi-level database may include a tree-based KV database at block 35 (e.g., LSM, B−tree, B+tree, etc.). Some embodiments of the method 30 may also include assigning the region to a NVM namespace at block 36. In any of the embodiments herein, the volatile memory may include an IMB of a SSD at block 37.

Embodiments of the method 30 may be implemented in a system, apparatus, computer, device, etc., for example, such as those described herein. More particularly, hardware implementations of the method 30 may include configurable logic such as, for example, PLAs, FPGAs, CPLDs, or in fixed-functionality logic hardware using circuit technology such as, for example, ASIC, CMOS, or TTL technology, or any combination thereof. Alternatively, or additionally, the method 30 may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

For example, the method 30 may be implemented on a computer readable medium as described in connection with Examples 20 to 25 below. Embodiments or portions of the method 30 may be implemented in firmware, applications (e.g., through an application programming interface (API)), or driver software running on an operating system (OS). Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

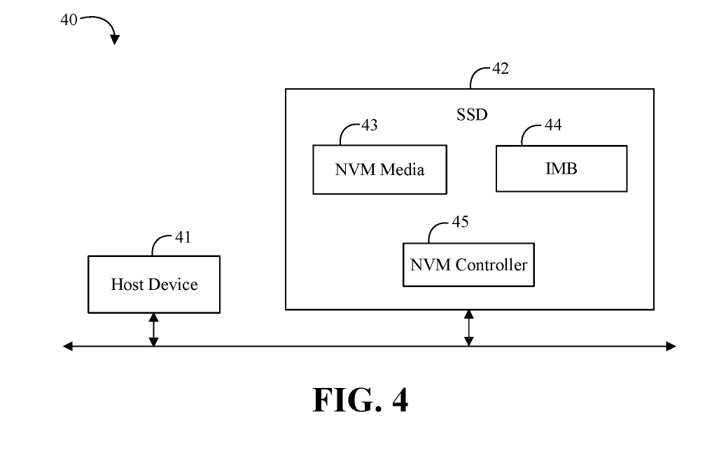

Turning now to FIG. 4, an embodiment of an electronic processing system 40 may include a host device 41 communicatively coupled to a SSD 42. The SSD 42 may include NVM media 43 (e.g., NAND-based memory technology, PCM-based technology such as INTEL 3D XPOINT, etc.) and an IMB 44 (e.g., backed-up volatile memory technology such as DRAM, such that from the perspective of the host device 41, the IMB 44 appears as non-volatile, and has essentially infinite endurance). The SSD 42 may also include a NVM controller 45 which may include logic and technology to make the SSD 42 compatible with NVMe. In some embodiments, the NVM controller 45 may define a namespace for at least a portion of the IMB 44, and designate the namespace as a part of the NVM media 43. In some embodiments, the host device 41 and/or the NVM controller 45 may be configured to prioritize data for storage to the IMB namespace based on one or more of a frequency of write operations for the data and a size of the data. For example, the host device 41 and/or the NVM controller 45 may prioritize information from a multi-level database for storage to the IMB namespace based on a level of the information in the multi-level database. For example, the multi-level database may include an LSM tree-based KV database, and the host device 41 may decide which data or files are to be put on the IMB namespace (e.g., including which levels of the LSM KV database).

Embodiments of the host device 41, the SSD 42, the NVM media 43, the IMB 44, the NVM controller 45, and other components of the system 40, may be implemented in hardware, software, or any combination thereof including at least a partial implementation in hardware. For example, hardware implementations may include configurable logic such as, for example, PLAs, FPGAs, CPLDs, or fixed-functionality logic hardware using circuit technology such as, for example, ASIC, CMOS, or TTL technology, or any combination thereof. Additionally, portions of these components may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

Some embodiments may advantageously utilize a SSD with an IMB to reduce write-amplification (WA) and to improve quality-of-service (QoS) in an LSM tree-based KV database. For example, RocksDB may be widely used in datacenter KV databases. Some implementations of a KV database may produce a large host WA, which may be due to compaction operations that move data in one level and compact/merge the data into the next level. When run on NAND-based SSDs, some implementations may also generate a large SSD-level WA. For example, intermingling of file-writes from different threads/applications may cause writes with different velocities to be placed together in the same reclaim units at the device level. As a result, some prominent use-cases may require high endurance and/or overprovisioned SSDs to compensate for the combined net write amplification compounded by the host and device level WAs. Advantageously, some embodiments may utilize an IMB namespace/region, which may have virtually infinite endurance and very low latency, as the primary storage space for ‘hot’ files (e.g., such as write ahead log, level 0 and 1 files, etc.) in a LSM tree-based KV database.

In some embodiments, only the higher-numbered level sorted-string table (SSTable) files (e.g., those files lower in the LSM tree) may be written to NAND media at runtime, and consume NAND-based endurance. For example, the higher-numbered level SSTable files may involve large sequential writes and may be written by the host much less frequently than the lower-numbered level files. In some embodiments, the SSD may no longer have small random writes (e.g., such as the data written to the write ahead log, system metadata, etc.) mixed with the large sequential writes (e.g., the SSTable files) in the primary namespace(s). Advantageously, although the host may still write the same amount of data to the SSD, some embodiments may significantly reduce the endurance requirement for the SSD. For example, some embodiments may allow a lower endurance SSD with an appropriately configured IMB namespace to meet/exceed an endurance requirement of a LSM tree-based KV database. Some embodiments may also improve QoS because the hot data may be stored in a low latency persistent memory (e.g., an IMB backed up by either internal or external energy during power cycle).

While some embodiments are described in the context of LSM-trees and NAND-based SSDs, those skilled in the art will appreciate that other embodiments may be applied to other data structures and storage technologies. For example, some KV databases may use B-trees or B-epsilon trees. Other database implementations, such as HASHDB, may also benefit from some embodiments by placing hot-write-content in the IMB, and other data on the NAND-based media. Some embodiments may use INTEL OPTANE technology, and may reduce writes issued to 3D XPOINT memory by absorbing many of such writes at runtime in the IMB region.

Some other systems may use a hash table for KV indexing, and multiple logical bands for KV pair storage. While WA may be reduced significantly (and the SSD endurance requirement may be lowered), the hash table/multiple band approach may require changes to the algorithms for the existing KV system. Some embodiments may advantageously require little or no change to the existing KV system. Some embodiments may even be combined with the hash table/multiple band approach to place the hot data in the IMB for further reduction of device level WA. Some other systems may utilize write-logging and disk-caching to nonvolatile dual-inline memory modules (NVDIMMs) to reduce WA. However, NVDIMMs may not be a suitable form factor for some KV database implementations and may introduce additional complexity due to the potential separation of the NVDIMMs and the KV database storage.

Advantageously, some embodiments may reduce the number of writes to the primary SSD namespace(s) by using an IMB namespace as the storage space for the most frequent writes. For example, some embodiments may save the following ‘hot’ data of an n-level LSM tree-based KV database, in IMB, in priority order until the IMB capacity is utilized: (1) Write Ahead Log (WAL); (2) Other system metadata file; (3) SSTable files in level 0; (4) SSTable files in level 1; (5) SSTable files in level k−1 (for k=3 to n−1, until capacity of IMB is exceeded); and (6) portion or all of the SSTable files in Level k (k<n). Some embodiments may provide significant WA reduction for the LSM tree-based KV database without ecosystem change. In some embodiments, a low-endurance SSD with an appropriately configured IMB namespace may meet the same endurance requirement as a higher-endurance SSD without IMB namespace under the same workloads. Some embodiments may also provide better QoS because the hot data is stored in the low-latency IMB namespace.

Any suitable SSD with IMB technology may be used. For example, some SSDs may provide up to 1 gigabyte (GB) or more of DRAM capacity which may be suitably configured as described herein. In some embodiments, an IMB may correspond to a SSD DRAM region/namespace which may be backed up to NAND-based media during power cycles. Appropriately backed-up, the IMB may essentially be considered as a persistent memory region, and may be implemented as a regular NVMe namespace in accordance with some embodiments. Compared to the regular NVM (e.g., NAND-based) namespace, the IMB namespace may have infinite endurance and low write latency. In some embodiments, the host may access the IMB namespace via regular storage read/write commands and install a filesystem in the IMB namespace. When the host writes data to the IMB namespace, in accordance with some embodiments the write may consume zero NAND endurance, and there may be no NAND media writes. In some embodiments, the SSD may only flush the IMB data from DRAM to NAND during a system power cycle, which may be an infrequent event in some datacenter applications.

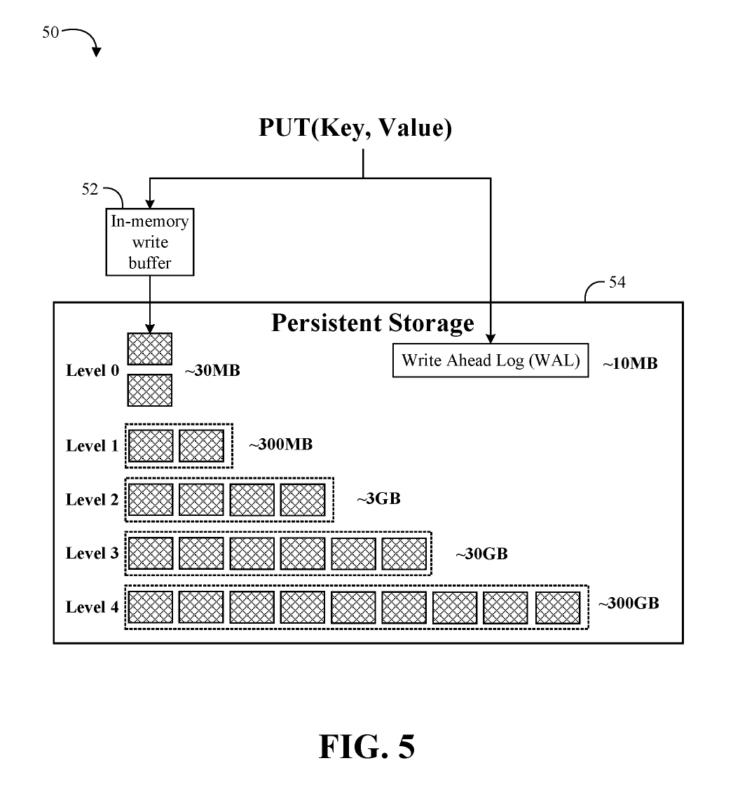

Turning now to FIG. 5, an embodiment of a storage system 50 may include an in-memory write buffer 52 and persistent storage 54. An embodiment of using an IMB as the storage for hot files in a LSM tree-based KV database may be better understood with reference to an example PUT operation. For example, every PUT(Key, Value) operation (e.g., a write operation) to the database may be written to two places including the in-memory write buffer 52 and a write ahead log (WAL) on the persistent storage 54. Files in the LSM tree-based KV database may be organized in multiple levels (e.g., in addition to the WAL and other system metadata), which may include level-1 (L1), level-2 (L2), etc. A special level-0 (L0) may contain files just flushed from the in-memory write buffer 52. Each level may have a target size, and the target size of each level may grow (e.g., exponentially). For example, as illustrated in FIG. 5, L0 may have a target size of 30 megabytes (MB), L1 may have a target size of 300 MB, L2 may have a target size of 3 GB, and so on. Compaction may trigger when the files in a certain level exceed the target size.

For typical workloads of LSM tree-based KV databases, compaction may happen more often at lower levels (e.g., between L0 and L1). For example, for every ten compaction/merging operations between L0 and L1, there may be only one compaction/merging operation between L1 and L2. In addition, the files in higher-numbered levels (e.g., lower levels in the tree as illustrated) may not be updated for a long time (e.g., days, or even weeks). In this case, more than 95% host writes may only access the ‘hot’ files. In some embodiments, the assigned IMB region may include at least the WAL, system metadata files, L0 and L1. Additional levels of the tree may be written to the IMB region, depending on the IMB region-capacity that is available. A partial level may be written as well for the last level that's placed in IMB. For a 1 GB IMB, for example, the hot files may include the WAL and other system metadata files (10 MB), plus the SSTable files in Level 0 (30 MB), plus the SSTable files in Level 1 (300 MB), with some IMB capacity left over for a portion of the SSTable files in Level 2 or other uses for the IMB. For a 4 GB IMB, for example, the hot files may further include all of the SSTable files in Level 2 (3 GB), with some IMB capacity left over for a portion of the SSTable files in Level 3 or other uses for the IMB.

Advantageously, embodiments utilizing the IMB as the primary storage space for such hot data may provide one or more of the following benefits: (1) small random writes (e.g., WAL and system metadata files) may be separated from large sequential writes (e.g., files in L0, L1, L2, etc.), and the NAND media may only serve for the large sequential writes, which may reduce the write amplification inside the SSD; (2) hot data (e.g., WAL, system metadata, files in L0 and L1, etc.) may be stored in the low latency IMB region, which may improve the QoS; (3) host writes to the NAND media may be reduced (e.g., by 50%): to fill up a 300 GB database, the host may write at least 300 GB to the WAL, 300 GB to L0, 300 GB to L1, 300 GB to L2, 297 GB to L3, and 267 GB to L4, with total writes from the host corresponding to 1764 GB; because the 1 GB IMB consumes zero NAND endurance, the total writes to the NAND media corresponds to 864 GB or a 51% host write reduction; (4) after the database is filled up, some typical workloads may consume zero SSD endurance: under typical workloads, there may be small random writes to the KV pairs that reside in L0 and L1 which may require compaction; such compaction may be performed entirely within the IMB and consume zero SSD endurance; and/or (5) by combining host-level and SSD-level write amplification reduction together, some embodiments may further reduce the write amplification of the LSM tree-based KV database (e.g., by at least 6 times).

### Additional Notes and Examples

Example 1 may include an electronic processing system, comprising a storage device including a volatile memory and nonvolatile memory, wherein at least a portion of the volatile memory is backed-up, a controller communicatively coupled to the storage device, and logic communicatively coupled to the controller to define a region for the backed-up portion of the volatile memory, and designate the region as a part of the nonvolatile memory.

Example 2 may include the system of Example 1, wherein the logic is further to prioritize data for storage to the region based on one or more of a frequency of write operations for the data and a size of the data.

Example 3 may include the system of Example 1, wherein the logic is further to prioritize information from a multi-level database for storage to the region based on a level of the information in the multi-level database.

Example 4 may include the system of Example 3, wherein the multi-level database includes a tree-based key-value database.

Example 5 may include the system of any of Examples 1 to 4, wherein the logic is further to assign the region to a nonvolatile memory namespace.

Example 6 may include the system of any of Examples 1 to 5, wherein the storage device includes a solid state drive and wherein the volatile memory includes an integrated memory buffer.

Example 7 may include a semiconductor apparatus, comprising one or more substrates, and logic coupled to the one or more substrates, wherein the logic is at least partly implemented in one or more of configurable logic and fixed-functionality hardware logic, the logic coupled to the one or more substrates to define a region for a backed-up portion of a volatile memory, and designate the region as a part of a nonvolatile memory.

Example 8 may include the apparatus of Example 7, wherein the logic is further to prioritize data for storage to the region based on one or more of a frequency of write operations for the data and a size of the data.

Example 9 may include the apparatus of Example 7, wherein the logic is further to prioritize information from a multi-level database for storage to the region based on a level of the information in the multi-level database.

Example 10 may include the apparatus of Example 9, wherein the multi-level database includes a tree-based key-value database.

Example 11 may include the apparatus of any of Examples 7 to 10, wherein the logic is further to assign the region to a nonvolatile memory namespace.

Example 12 may include the apparatus of any of Examples 7 to 11, wherein the volatile memory includes an integrated memory buffer of a solid state drive.

Example 13 may include the apparatus of any of Examples 7 to 12, wherein the logic coupled to the one or more substrates includes transistor channel regions that are positioned within the one or more substrates.

Example 14 may include a method of controlling memory, comprising defining a region for a backed-up portion of a volatile memory, and designating the region as a part of a nonvolatile memory.

Example 15 may include the method of Example 14, further comprising prioritizing data for storage to the region based on one or more of a frequency of write operations for the data and a size of the data.

Example 16 may include the method of Example 14, further comprising prioritizing information from a multi-level database for storage to the region based on a level of the information in the multi-level database.

Example 17 may include the method of Example 16, wherein the multi-level database includes a tree-based key-value database.

Example 18 may include the method of any of Examples 14 to 17, further comprising assigning the region to a nonvolatile memory namespace.

Example 19 may include the method of any of Examples 14 to 18, wherein the volatile memory includes an integrated memory buffer of a solid state drive.

Example 20 may include at least one computer readable storage medium, comprising a set of instructions, which when executed by a computing device, cause the computing device to define a region for a backed-up portion of a volatile memory, and designate the region as a part of a nonvolatile memory.

Example 21 may include the at least one computer readable storage medium of Example 20, comprising a further set of instructions, which when executed by the computing device, cause the computing device to prioritize data for storage to the region based on one or more of a frequency of write operations for the data and a size of the data.

Example 22 may include the at least one computer readable storage medium of Example 20, comprising a further set of instructions, which when executed by the computing device, cause the computing device to prioritize information from a multi-level database for storage to the region based on a level of the information in the multi-level database.

Example 23 may include the at least one computer readable storage medium of Example 22, wherein the multi-level database includes a tree-based key-value database.

Example 24 may include the at least one computer readable storage medium of any of Examples 20 to 23, comprising a further set of instructions, which when executed by the computing device, cause the computing device to assign the region to a nonvolatile memory namespace.

Example 25 may include the at least one computer readable storage medium of any of Examples 20 to 24, wherein the volatile memory includes an integrated memory buffer of a solid state drive.

Example 26 may include a storage controller apparatus, comprising means for defining a region for a backed-up portion of a volatile memory, and means for designating the region as a part of a nonvolatile memory.

Example 27 may include the apparatus of Example 26, further comprising means for prioritizing data for storage to the region based on one or more of a frequency of write operations for the data and a size of the data.

Example 28 may include the apparatus of Example 26, further comprising means for prioritizing information from a multi-level database for storage to the region based on a level of the information in the multi-level database.

Example 29 may include the apparatus of Example 28, wherein the multi-level database includes a tree-based key-value database.

Example 30 may include the apparatus of any of Examples 26 to 29, further comprising means for assigning the region to a nonvolatile memory namespace.

Example 31 may include the apparatus of any of Examples 26 to 30, wherein the volatile memory includes an integrated memory buffer of a solid state drive.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrase “one or more of A, B, and C” and the phrase “one or more of A, B, or C” both may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. An electronic processing system, comprising:
a storage device including a volatile memory and nonvolatile memory, wherein at least a portion of the volatile memory is backed-up;
a controller communicatively coupled to the storage device; and
logic communicatively coupled to the controller to:
define a region for the backed-up portion of the volatile memory, and
designate the region as a part of the nonvolatile memory.

2. The system of claim 1, wherein the logic is further to:
prioritize data for storage to the region based on one or more of a frequency of write operations for the data and a size of the data.

3. The system of claim 1, wherein the logic is further to:
prioritize information from a multi-level database for storage to the region based on a level of the information in the multi-level database.

4. The system of claim 3, wherein the multi-level database includes a tree-based key-value database.

5. The system of claim 1, wherein the logic is further to:
assign the region to a nonvolatile memory namespace.

6. The system of claim 1, wherein the storage device includes a solid state drive and wherein the volatile memory includes an integrated memory buffer.

7. A semiconductor apparatus, comprising:
one or more substrates; and
logic coupled to the one or more substrates, wherein the logic is at least partly implemented in one or more of configurable logic and fixed-functionality hardware logic, the logic coupled to the one or more substrates to:
define a region for a backed-up portion of a volatile memory, and
designate the region as a part of a nonvolatile memory.

8. The apparatus of claim 7, wherein the logic is further to:
prioritize data for storage to the region based on one or more of a frequency of write operations for the data and a size of the data.

9. The apparatus of claim 7, wherein the logic is further to:
prioritize information from a multi-level database for storage to the region based on a level of the information in the multi-level database.

10. The apparatus of claim 9, wherein the multi-level database includes a tree-based key-value database.

11. The apparatus of claim 7, wherein the logic is further to:
assign the region to a nonvolatile memory namespace.

12. The apparatus of claim 7, wherein the volatile memory includes an integrated memory buffer of a solid state drive.

13. The apparatus of claim 7, wherein the logic is integrated with a memory controller on the one or more substrates.

14. The apparatus of claim 7, wherein the logic coupled to the one or more substrates includes transistor channel regions that are positioned within the one or more substrates.

15. A method of controlling memory, comprising:
defining a region for a backed-up portion of a volatile memory; and
designating the region as a part of a nonvolatile memory.

16. The method of claim 15, further comprising:
prioritizing data for storage to the region based on one or more of a frequency of write operations for the data and a size of the data.

17. The method of claim 15, further comprising:
prioritizing information from a multi-level database for storage to the region based on a level of the information in the multi-level database.

18. The method of claim 17, wherein the multi-level database includes a tree-based key-value database.

19. The method of claim 15, further comprising:
assigning the region to a nonvolatile memory namespace.

20. The method of claim 15, wherein the volatile memory includes an integrated memory buffer of a solid state drive.
